(19) United States
(12) Patent Application Publication
(10) Pub. No.: US 2026/0141439 A1
(43) Pub. Date: May 21, 2026

(54) INFORMATION PROCESSING SYSTEM AND SERVER DEVICE

(71) Applicant: Toshiba Tec Kabushiki Kaisha, Tokyo (JP)

(72) Inventor: Isao TAKAHASHI, Fuji Shizuoka (JP)

(21) Appl. No.: 19/305,369

(22) Filed: Aug. 20, 2025

(30) Foreign Application Priority Data
Nov. 19, 2024 (JP) 2024-201240

(51) Int. Cl. G06Q 30/0601; G06F 21/62; G06Q 50/12

(52) U.S. Cl. CPC G06Q 30/0633; G06F 21/6254; G06Q 50/12

(57) ABSTRACT

According to one embodiment, a store data handling system includes a server device and a store management device that acquires electronic data from a purchase handling device of a store. The server device has a processor and a storage unit storing an output destination table. The processor stores the electronic data received from the store management device in the storage unit, compares the electronic data to output conditions in the output destination table to determine an output destination for the electronic data, identifies an output address of the determined output destination, processes the electronic data based on additional information in the output destination table associated with the output address, and controls the communication interface to transmit the processed electronic data to the output address.

### CROSS-REFERENCE TO RELATED APPLICATION

This application is based upon and claims the benefit of priority from Japanese Patent Application No. 2024-201240, filed Nov. 19, 2024, the entire contents of which are incorporated herein by reference.

### FIELD

Embodiments described herein relate generally to an information processing system and a server device.

### BACKGROUND

In the related art, in a store such as a restaurant, a system that receives orders from both inside (in-store orders) and outside (external orders) the store but collectively manages all the received orders has been proposed. In such a system, electronic data related to commercial transactions of the store, such as order data and sales data of the store, is collected and managed by a server device of a company that operates or manages the store.

There may be customers who want to share electronic data related to a commercial transaction at the store with other companies (hereinafter referred to as “partners”) associated or partnered with the store (or the store operating company). For example, when a food delivery service provided by a partner is used for receiving an order from outside the store and delivering the ordered merchandise, the partner may request provision of electronic data (or portions thereof) related to food delivery services.

However, in the system in the related art, since a mechanism for automatically providing the electronic data collected by the store to the partner is not considered at all, it can be necessary to manually transmit the electronic data to each of the partners. Therefore, there is room for improvement in terms of convenience in data cooperation with a partner company in the systems in the related art.

### BRIEF DESCRIPTION OF THE DRAWINGS

FIG. 1 is a diagram illustrating a system configuration according to an embodiment.

FIG. 2 is a block diagram of a store management device.

FIG. 3 is a block diagram of a store management server.

FIG. 4 is a diagram illustrating a data configuration of an output destination specification table.

FIG. 5 depicts functional configurations of a store management device and a store management server.

FIG. 6 is a sequence diagram of a process executed by a handy terminal, a store management device, a slip printer, a POS terminal, a store management server, and an information terminal.

FIG. 7 is a sequence diagram of a process executed by a store management device, a POS terminal, a store management server, and an external server.

### DETAILED DESCRIPTION

An information processing system and a server device capable of efficiently providing electronic data related to a commercial transaction performed in a store to a partner are provided.

In general, according to one embodiment, a store data handling system includes a server device and a store management device configured to acquire electronic data related to merchandise sold by a store from a purchase handling device of the store. The server device includes a storage unit storing an output destination specification table; a communication interface connected to the store management device via a network to receive the electronic data from the store management device; and a processor. The processor is configured to: store the electronic data received from the store management device in the storage unit; compare the electronic data to output conditions in the output destination specification table to determine an output destination for the electronic data; identify an output address of the determined output destination in the output destination specification table, the output address being an electronic address of an external server; process the electronic data based on additional information in the output destination specification table associated with the output address; and control the communication interface to transmit the processed electronic data to the output address.

Hereinafter, certain example embodiments of an information processing system and a server device will be described with reference to the drawings. The disclosure is not limited to these example embodiments.

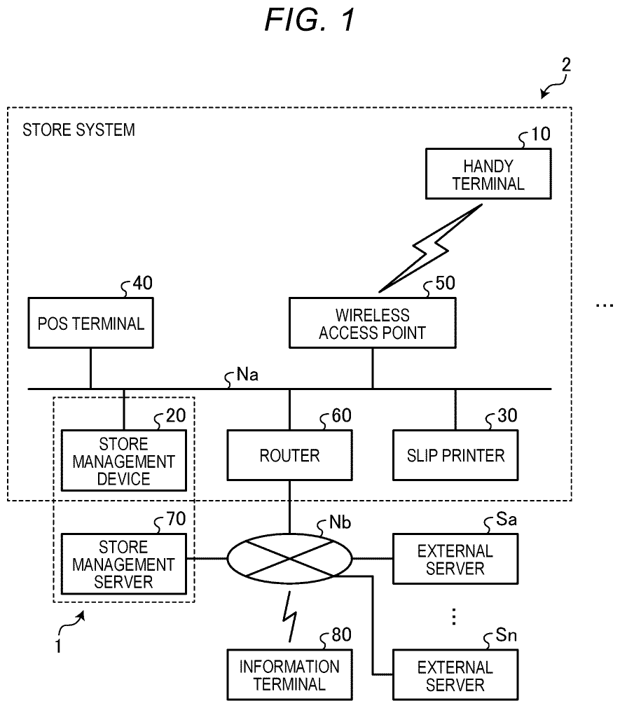

FIG. 1 is a diagram illustrating an example of a system configuration according to an embodiment. A system according to the present embodiment is, for example, a system in which electronic data, such as order data related to orders received from inside or outside a store and sales data, is managed by a server device. The server device may then provide the electronic data (or portions thereof) to an external server of a partner.

The system in this embodiment includes a handy terminal 10 (e.g., a handheld, mobile, or portable terminal), a store management device 20, a slip printer 30, a POS terminal 40, a wireless access point 50, a router 60, a store management server 70, an information terminal 80, and one or more external servers. FIG. 1 illustrates different external servers Sa and Sn as examples of the plurality of external servers. Hereinafter, unless otherwise specified, reference to an external server refers to any one of the plurality of external servers included in the system. Here, the store management device 20 and the store management server 70 constitute an information processing system 1. The handy terminal 10, the store management device 20, the slip printer 30, the POS terminal 40, the wireless access point 50, and the router 60 constitute a store system 2.

The configuration of the information processing system 1 is not limited to the above-described example. For example, the information processing system 1 may incorporate one or more aspects of the store system 2. The information processing system 1 may comprise one or more external servers.

A network Na is, for example, a network such as a local area network (LAN) provided in a store. The network Nb is, for example, a network such as the Internet.

The devices of the store system 2 are communicably connected via the network Na. The store system 2, the store management server 70, the information terminal 80, and one or more external servers are communicably connected via the network Nb. The handy terminal 10 is connected to the network Na via the wireless access point 50. The router 60 connects the network Na and the network Nb to each other.

Although only one handy terminal 10, one slip printer 30, one POS terminal 40, and one wireless access point 50 are illustrated in FIG. 1, a plurality of handy terminals 10, a plurality of slip printers 30, a plurality of POS terminals 40, and a plurality of wireless access points 50 may be included, and the number of handy terminals 10, slip printers 30, POS terminals 40, and wireless access points 50 can be freely set.

The handy terminal 10 is, for example, a terminal device operated by a clerk of a store. Data (order data) related to an order received from a customer visiting the store can be input via the handy terminal 10. The handy terminal 10 transmits the order data that includes, for example, a menu code for identifying the ordered merchandise, such as ordered food and/or drink and a table number for identifying a seat of the customer placing the order to the store management device 20 via the wireless access point 50 and the network Na.

The order data includes a transaction number (also referred to as a transaction ID) for uniquely identifying an order, a company ID for uniquely identifying a company that provides a service used by a customer or a partner company, a service ID for uniquely identifying a service such as a food delivery service used by a customer, information indicating an order form when a customer orders merchandise, and the like. The company ID may be a company ID of a company that provides a delivery service used by a customer. When a delivery service or the like is not used, the company ID and the service ID may not be included in the order data or are left blank.

The order form is used when a customer orders merchandise. Examples of an order form include a takeout form by which merchandise ordered by a customer is received in the store and then taken from the store, an eat-in form by which merchandise ordered by a customer is received in the store and then eaten in the store, and a delivery form by which merchandise ordered by a customer is delivered to a location specified by the customer.

The order data or a sales file generated by the POS terminal 40 may include a service ID of an electronic settlement service used by a customer for paying a merchandise (order) price and a company ID of a company that provides the electronic settlement service.

The store management device 20 is an example of an information processing device. The store management device 20 is provided, for example, in a backroom of the store. The store management device 20 receives and manages the order data transmitted from the handy terminal 10. The store management device 20 receives and manages the order data transmitted from the store management server 70.

The store management device 20 receives and manages the sales file from a POS terminal 40. Details of the sales file will be described below. The store management device 20 may be provided outside the store in a location such as a head office or a data center that manages the store system 2.

The slip printer 30 is provided, for example, in the kitchen of the store. The slip printer 30 prints a cooking slip for notifying a chef, cook, or the like of the information included in order data received from a customer. The slip printer 30 may be referred to as a kitchen printer. Instead of the slip printer 30 or in addition to the slip printer 30, a kitchen display that displays a screen for notifying the chef, cook, or the like of the order data may be used.

The POS terminal 40 is provided, for example, at a checkout counter of the store. The POS terminal 40 includes a control unit having a computer configuration and performs a settlement process for settling the purchase price related to provision of merchandise to a customer based on the order data. The POS terminal 40 generates and manages the sales file including the order data, settlement information storing details of the settlement process, and electronic data such as sales data of merchandises provided in the store and selling data.

In the present embodiment, a sales file is generated every time the store management device 20 receives order data, in other words, for every transaction.

The store management server 70 is an example of a server device. The store management server 70 can be provided outside the store at location such as a head office or a data center that manages the store system 2. The store management server 70 receives an order related to provision of merchandise by a store for which the store system 2 is provided in response to a request (order) of a customer at the information terminal 80. Hereinafter, such an order via the information terminal 80 is referred to as a pre-order. The store management server 70 stores and manages a list of items that can be a pre-ordered at the store or each store associated with the store management server 79. Note that, in the present example, list of items that can be pre-ordered includes menu item names, unit prices, and the like.

The store management server 70 also receives and manages the sales file(s) from the store management device 20. The store management server 70 may identify an external server to send a sales file based on an output destination specification table 722, then send the sales file to the identified external server.

The information terminal 80 may be any terminal or computer that can be operated by a customer to send a merchandise order or the like. For example, information terminal 80 may be any terminal capable of performing data communication via the network Nb, such as a smartphone, a tablet terminal, or another type of computer terminal. It is assumed in this example that an application program for using a service provided by the store management server 70 for making a pre-order has been installed in the information terminal 80.

The external server (one of external server Sa . . . Sn) is, for example, a server device managed and operated by a partner company. The external server is a server device that may receive the electronic data (such as sales files) managed by the store system 2 and the store management server 70. As illustrated in FIG. 1, a plurality of external servers (Sa . . . Sn) may be communicably connected to the store system 2 via the network Nb.

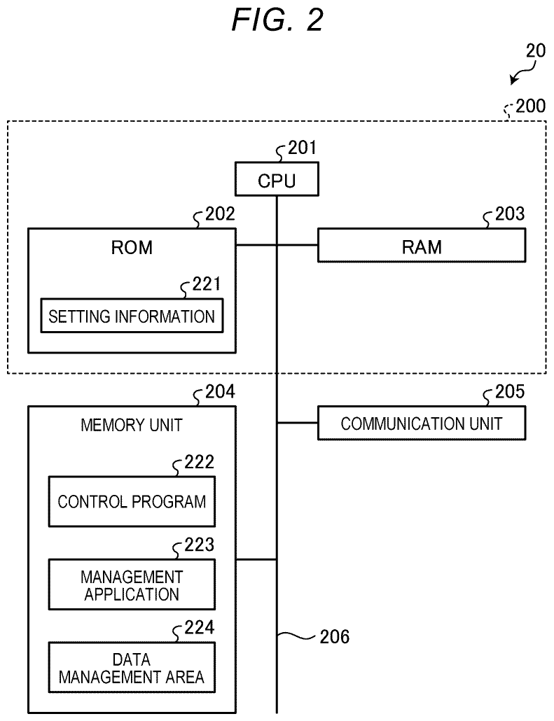

FIG. 2 is a block diagram illustrating an example of the hardware configuration of the store management device 20 according to the embodiment. As illustrated in FIG. 2, the store management device 20 includes a central processing unit (CPU) 201, a read only memory (ROM) 202, a random access memory (RAM) 203, a memory unit 204, and a communication unit 205.

The CPU 201 is an example of a processor and performs overall control of the components of the store management device 20. The ROM 202 stores various programs executable by the CPU 201 and setting information 221. The setting information 221 includes, for example, a store ID for uniquely identifying a store in which the store management device 20 is provided, and settings for operating a management application 223 or the like. The RAM 203 is a workspace for loading programs and various types of data.

The memory unit 204 includes a nonvolatile memory such as a hard disk drive (HDD) or a solid state drive (SSD) that stores stored information even when power is turned off. The memory unit 204 includes a control program 222, the management application 223, and a data management area 224. The control program 222 is a control program for controlling the store management device 20.

The CPU 201, the ROM 202, the RAM 203, and the memory unit 204 are connected to one another via a bus 206. The CPU 201, the ROM 202, and the RAM 203 constitute a control unit 200 having a computer configuration. That is, the control unit 200 executes a control process of the store management device 20 by the CPU 201 operating according to the control program 222 stored in the ROM 202 or the memory unit 204 and loaded into the RAM 203.

The communication unit 205 is a communication interface for performing communication via the network Na. The communication unit 205 transmits and receives various types of information to and from an external device such as the POS terminal 40 connected to the network Na.

The management application 223 is a program (e.g., software) for executing a series of processes for managing the order data. The data management area 224 stores, for example, the order data and the sales file.

Next, a hardware configuration of the store management server 70 will be described.

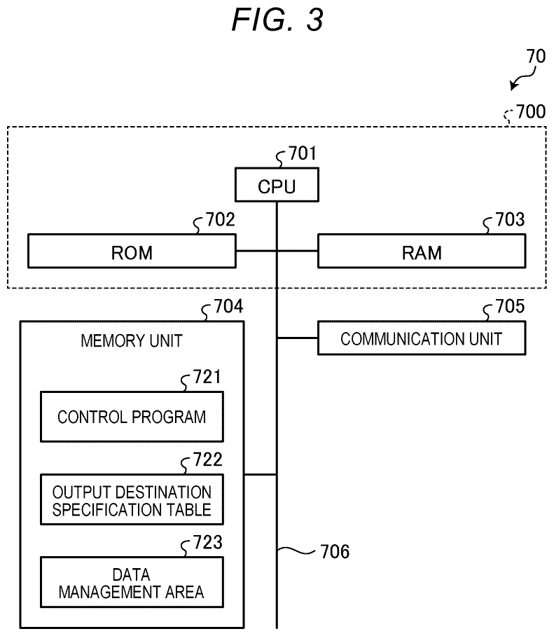

FIG. 3 is a block diagram illustrating an example of the hardware configuration of the store management server 70 according to the embodiment. As illustrated in FIG. 3, the store management server 70 includes a CPU 701, a ROM 702, a RAM 703, a memory unit 704, a communication unit 705, and the like.

The CPU 701 is an example of a processor, and performs overall control of the units of the store management server 70. The ROM 702 stores various programs. The RAM 703 is a workspace for loading programs and various types of data.

The memory unit 704 is implemented by a nonvolatile memory such as an HDD or an SSD that stores stored information even when the power is turned off. The memory unit 704 includes a control program 721, an output destination specification table 722, and a data management area 723. The control program 721 is a control program for controlling the store management server 70.

The CPU 701, the ROM 702, the RAM 703, and the memory unit 704 are connected to one another via a bus 706. The CPU 701, the ROM 702, and the RAM 703 constitute a control unit 700 having a computer configuration. That is, the control unit 700 executes a control process of the store management server 70 by the CPU 701 operating according to the control program 721 stored in the ROM 702 or the memory unit 704 and loaded into the RAM 703.

The communication unit 705 is a communication interface for performing communication via the network Nb. The communication unit 705 transmits and receives various types of information to and from the router 60, the information terminal 80, the external server, and the like connected to the network Nb.

The output destination specification table 722 is a data table or a database in which output destinations for the sales files managed by the store management server 70 are set.

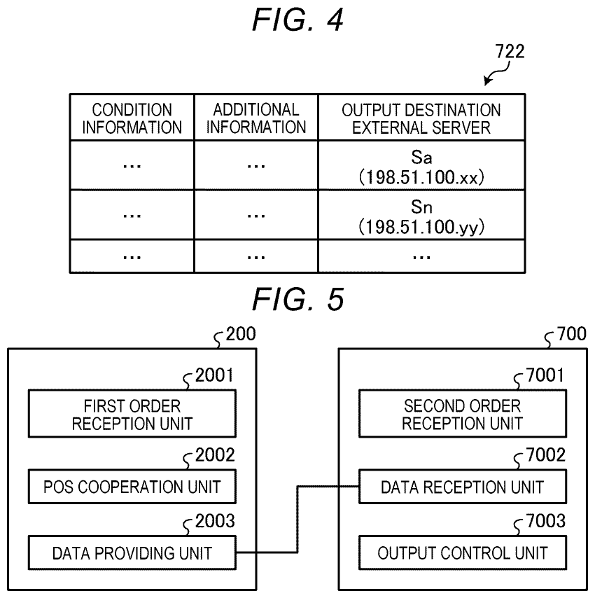

FIG. 4 is a diagram illustrating an example of a data configuration of the output destination specification table 722 according to the embodiment. As illustrated in FIG. 4, the output destination specification table 722 stores an output destination external server and the like in association with condition information and additional information.

In this context, condition information indicates the conditions under which a sales file is to be output to an external server. For example, a company ID and/or a service ID can be set in the condition information so when a sales file includes or matches a particular company ID and/or a particular service ID, the sales file may be sent to a particular external server. In addition, an indication of the order form used when the merchandise was ordered may be set as the condition information. It may be preferable to set a condition according to the company associated with the output destination external server (external server) in the condition information. For example, a service ID “01” may be set as the condition information for a company that provides a service corresponding to the service ID “01”. The conditions set in the condition information are not limited to the above examples, and elements included in the sales file can be freely set.

In the current context, additional information indicates additional processing content to be executed when the sales file is output to the external server. The additional information is, for example, settings for a method of formatting (editing, processing, or the like) the sales file.

The additional information may store data to be included in (e.g., appended to) the sales file or indicate a type of a processing to be performed on the data in the sales file before output. The data to be added/appended may be, for example, a predetermined character string or a predetermined data field. The type of processing to be performed on the sales file may be, for example, deletion of certain data, conversion of data from one type to another, conversion of one character stinge to another character string, a masking process to protect or anonymize data in the sales file when specific sharing is prohibited to a person other than a third party having particular authority to view the unmasked data, or the like. In general, any method can be adopted as a method of generating or formatting a sales file in view of the additional information or the like.

In this manner, by formatting the sales file based on the additional information, it is possible to limit the information in the original sales file that is provided to the partner company, and thus it is possible to ensure security or privacy as necessary.

The output destination external server stores information indicating the external server to be used as an output (transmission) destination of the sales file. In the output destination external server, for example, an IP (Internet Protocol) address of the external server is stored (set). In FIG. 4, certain external servers Sa and Sn are also illustrated for explanation. The number of external servers (IP addresses) set as output destination for any particular sales file may be plural. The information indicating a particular output destination external server is not limited to an IP address, and other identifying information may set an identifier for uniquely identifying an external server.

Returning to FIG. 3, the data management area 723 stores the sales file received from the store management device 20. The data management area 723 may store the sales file in association with a store ID of the store in which the store management device 20 is provided, a date and time received from the store management device 20, and the like.

Next, functional aspects of the store management device 20 and the store management server 70 will be described. FIG. 5 is a block diagram illustrating an example of the functional configurations of the store management device 20 and the store management server 70 according to the embodiment.

As illustrated in FIG. 5, the control unit 200 of the store management device 20 provides functions of a first order reception unit 2001, a POS cooperation unit 2002, and a data providing unit 2003.

Specifically, the control unit 200 (CPU 201) of the store management device 20 executes the control program 222 stored in the memory unit 204 to implement the above-described functional aspects. In the present embodiment, the functional configuration relates to a software configuration implemented by cooperation between the processor and the program of the store management device 20, but the embodiment is not limited thereto, and one or more described functions may be provided by a hardware configuration in which a part or all of the functions are implemented by a dedicated circuit or the like.

The first order reception unit 2001 manages the order data received from the handy terminal 10 and the store management server 70. For example, when the order data is received from the handy terminal 10, the first order reception unit 2001 stores the order data in the data management area 224 of the memory unit 204. When the order data is received from the store management server 70, the first order reception unit 2001 stores also the order data in the data management area 224 of the memory unit 204.

Whenever the order data is received from the handy terminal 10 or the store management server 70, the first order reception unit 2001 instructs the slip printer 30 to print a cooking slip including the just received order data.

The POS cooperation unit 2002 is an example of an acquisition unit. The POS cooperation unit 2002 transmits and receives various types of information to and from the POS terminal 40. For example, the POS cooperation unit 2002 receives a transaction number transmitted from the POS terminal 40. The POS cooperation unit 2002 transmits the order data corresponding to the transaction number to the POS terminal 40.

The POS cooperation unit 2002 receives (acquires) and manages various types of data from the POS terminal 40. For example, the POS cooperation unit 2002 instructs the POS terminal 40 to transmit the sales file and receives the sales file transmitted from the POS terminal 40 that receives the instruction.

When a sales file is received from the POS terminal 40, the POS cooperation unit 2002 stores the sales file in the data management area 224 of the memory unit 204.

Any method and any timing for acquiring the various types of data from the POS terminal 40 can be adopted. For example, the method for acquiring data from the POS terminal 40 may be a pull-type acquisition method. A push-type acquisition method of requesting the data from the POS terminal 40 and then acquiring the data transmitted from the POS terminal 40 in response to the request may be adopted.

The data providing unit 2003 is an example of a transmission unit. The data providing unit 2003 transmits (provides) various types of data to the store management server 70. For example, the data providing unit 2003 transmits the store ID for uniquely identifying a store stored in the setting information 221 and the sales file stored in the data management area 224 of the memory unit 204 that are in association with each other to the store management server 70.

The data providing unit 2003 may execute transmission of the sales file to the store management server 70 at any timing. For example, the data providing unit 2003 may collectively transmit the sales files stored in the data management area 224 over a predetermined increment of time (for example, every 24 hours). In addition, it may be preferable that the data management area 224 be controlled so that sales files are not redundantly transmitted, for example, by deleting a sales file from the data management area 224 after it is transmitted.

The method adopted by the data providing unit 2003 for transmitting a sales file is not particularly limited. For example, the data providing unit 2003 may transmit the sales file by an application programming interface (API).

The control unit 700 of the store management server 70 includes a second order reception unit 7001, a data reception unit 7002, and an output control unit 7003 as functional configurations.

Specifically, the control unit 700 (CPU 701) of the store management server 70 executes the control program 721 stored in the memory unit 704 to implement the above-described functions. In the present embodiment, the functions are provided by a software configuration implemented by cooperation between the processor and the program of the store management server 70, but the embodiment is not limited thereto, and a hardware configuration in which a part or all of the functions are implemented by a dedicated circuit or the like may be adopted. In addition, the functions of the store management server 70 are not limited to those described.

The second order reception unit 7001 receives an order of merchandise for the store from the information terminal 80. For example, the second order reception unit 7001 receives an order content from the information terminal 80 operated by the customer. In this context, the order content includes, for example, information such as a store from which a customer is ordering merchandise, and merchandise information about the merchandise selected by the customer from among the merchandise available for order from the store. In general, merchandise is selected by the customer through a dedicated application activated by the customer on the information terminal 80.

When the order content is received from the information terminal 80, the second order reception unit 7001 generates the order data based on the received order content. The second order reception unit 7001 transmits the generated order data to the store management device 20 of the store (order destination) to which the order is directed.

The data reception unit 7002 receives and manages various types of data from the store management device 20. For example, when the sales file and the store ID are received from the store management device 20, the data reception unit 7002 stores the sales file in the data management area 723 of the memory unit 704.

The output control unit 7003 outputs a sales file managed by the store management server 70 to an external server.

Specifically, the output control unit 7003 identifies the corresponding condition information by referring to the condition information in the output destination specification table 722 and comparing the condition information to the information included in the sales file. For example, the output control unit 7003 determines whether there is condition information matching the service ID, the order form type, or the like included in the sales file. Then, the output control unit 7003 specifies an output destination external server corresponding to the specified (matched) condition information.

The output control unit 7003 selects sales files to be output to the an output destination external servers by executing the above-described process on the sales files. In other words, the output control unit 7003 extracts a sales file from the sales files managed (stored) by the store management server 70 that matches a output condition for at least one of the output destination external servers.

The output control unit 7003 may also perform a process corresponding the output destination on a sales file based on information set in the output destination specification table 722 indicating processing to be performed on the sales file, and then output the accordingly processed sales file to the output destination.

Specifically, the output control unit 7003 refers to the output destination specification table 722, and formats the sales file based on the additional information corresponding to the specified condition information.

For example, when there is an instruction in the additional information of the output destination specification table 722 to perform a masking process (so that partial information stored in the sales file is obscured or deleted) before output, the output control unit 7003 executes the masking process on the sales file.

Then, the output control unit 7003 outputs (transmits) the formatted sales file to the external server corresponding to the output destination.

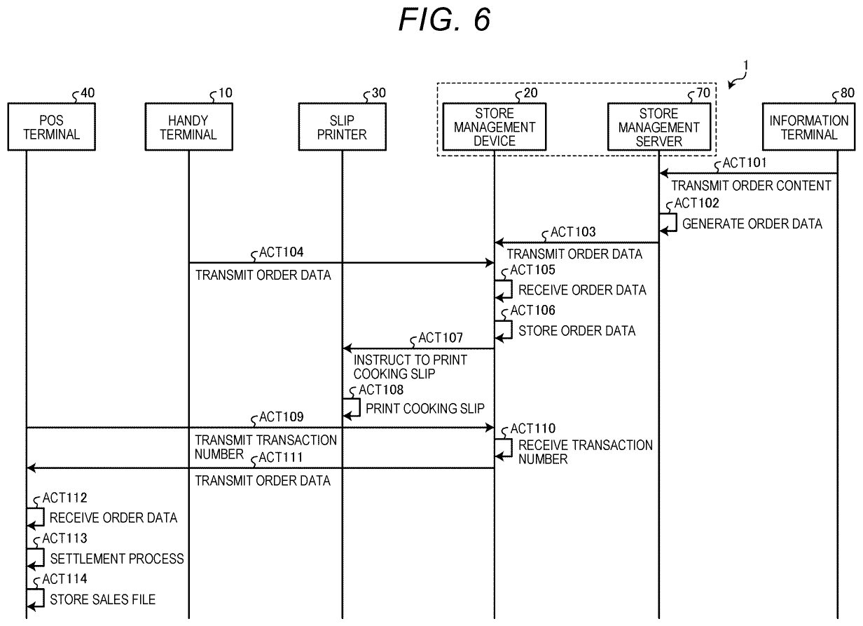

FIG. 6 is a sequence diagram illustrating an example of a process executed by the handy terminal 10, the store management device 20, the slip printer 30, the POS terminal 40, the store management server 70, and the information terminal 80 according to the embodiment. The sequence diagram illustrated in FIG. 6 illustrates a processing example for when the order data is generated based on the order content from the customer, and then transmitted to the POS terminal 40 and stored (managed).

First, a customer who intends to place an order from the outside of the store activates a dedicated application on the information terminal 80, and transmits order content to the store management server 70 by operating the information terminal 80 (ACT101).

When the order content is received from the information terminal 80, the second order reception unit 7001 of the store management server 70 generates order data based on the received order content (ACT102). Next, the second order reception unit 7001 transmits the order data to the store management device 20 (ACT103).

The order data of an order received from the customer placing the order at a counter or inside the store with a store clerk or the like is transmitted to the store management server 70 (ACT104).

Next, when the order data is received via the handy terminal 10 or the store management server 70 (ACT105), the first order reception unit 2001 of the store management device 20 stores the order data in the data management area 224 (ACT106). Next, the first order reception unit 2001 instructs the slip printer 30 to print a cooking slip including the order data (ACT107).

When the instruction is received from the store management device 20, the slip printer 30 prints the cooking slip (ACT108).

When the POS terminal 40 receives aa transaction number (uniquely identifying the order) from the store clerk or the like, the POS terminal 40 transmits the transaction number to the store management device 20 (ACT109). In this example, the transaction number may be input to the POS terminal 40 by typing the transaction number printed on the cooking slip.

When the transaction number is received from the POS terminal 40 (ACT110), the store management device 20 transmits the order data corresponding to the received transaction number to the POS terminal 40 (ACT111).

Next, after the order data is received from the store management device 20 (ACT112), the POS terminal 40 performs the settlement process based on the order data (ACT113). After the settlement process is completed, the POS terminal 40 generates a sales file including a breakdown (itemized summary) of the settlement process and the order data, and stores the sales file in a storage unit (ACT114).

By the above-described process, the POS terminal 40 generates a sales file of the merchandise ordered from inside or outside the store for every transaction, and stores the generated sales file in a storage unit or the like.

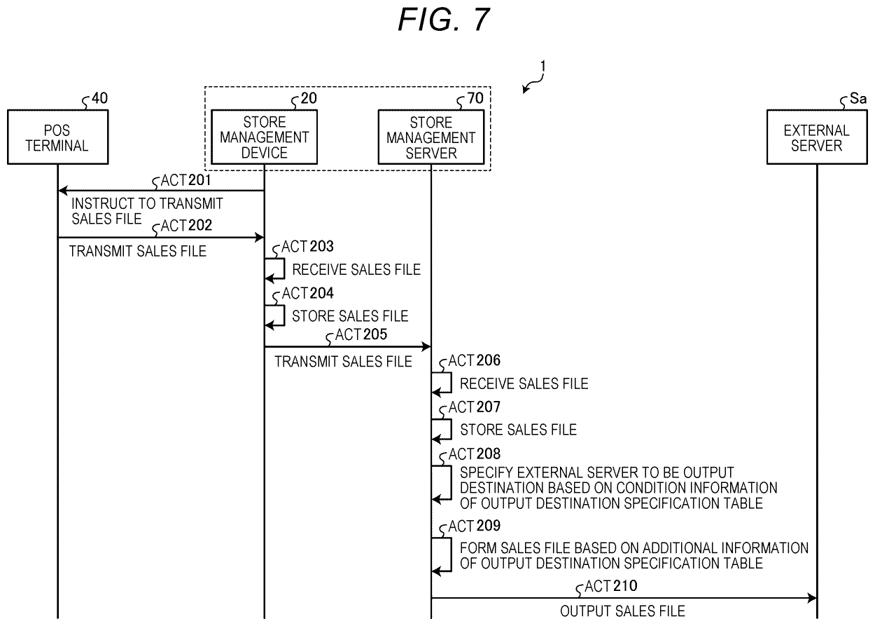

FIG. 7 is a sequence diagram illustrating an example of a process executed by the store management device 20, the POS terminal 40, the store management server 70, and the external server Sa according to the embodiment. The sequence diagram illustrated in FIG. 7 illustrates an example in which the store management device 20 acquires the sales file from the POS terminal 40, transmits the sales file to the store management server 70, and then outputs the sales file to the output destination specified by the store management server 70.

First, the POS cooperation unit 2002 of the store management device 20 instructs the POS terminal 40 to transmit the sales file (ACT201). After the POS terminal 40 receives a transmission instruction for a sales file, the POS terminal 40 transmits the sales file to the store management device 20 (ACT202).

Next, when the sales file is received from the POS terminal 40 (ACT203), the POS cooperation unit 2002 stores the sales file in the data management area 224 of the memory unit 204 (ACT204). Next, the data providing unit 2003 of the store management device 20 transmits the sales file and the store ID (stored in the setting information 221 of the store management device 20) that are associated with each other to the store management server 70 (ACT205).

After the sales file and the store ID are received from the store management device 20 (ACT206), the data reception unit 7002 of the store management server 70 stores the sales file in the data management area 723 of the memory unit 704 (ACT207).

Next, the output control unit 7003 of the store management server 70 refers to the output destination specification table 722, and identifies the condition information corresponding to the information stored in the sales file. Then, the output control unit 7003 refers to the output destination specification table 722, and identifies an output destination external server corresponding to the identified condition information (ACT208).

Next, the output control unit 7003 refers to the output destination specification table 722 and formats the sales file based on any additional information corresponding to the condition information identified in ACT208 (ACT209). Then, the output control unit 7003 outputs the formatted sales file to the output destination external server (which is indicated as the external server Sa in FIG. 7) identified in ACT208 (ACT210).

When the sales file received from the store management device 20 does not need to be formatted, the output control unit 7003 of the store management server 70 may omit ACT209.

By the above-described process, the store management device 20 transmits a sales file received (acquired) from the POS terminal 40 to the store management server 70. The store management server 70 can then output the sales file to the external server Sa specified in the output destination specification table 722.

As described above, the information processing system 1 according to the present embodiment includes the store management device 20 and the store management server 70. The store management device 20 includes the POS cooperation unit 2002 that acquires the sales file related to a commercial transaction of the merchandise sold in the store from the POS terminal 40 on which the commercial transaction was performed. The data providing unit 2003 transmits the sales file acquired by the POS cooperation unit 2002 to the store management server 70. The store management server 70 includes the data reception unit 7002 that receives the sales file transmitted by the data providing unit 2003 and the output control unit 7003 that outputs the received sales file to an output destination set in the output destination specification table 722.

Accordingly, the store management device 20 of the information processing system 1 transmits a sales file received from the POS terminal 40 to the store management server 70. Then, the store management server 70 outputs the sales file received from the store management device 20 to an external server of a partner based on a setting of the output destination in the output destination specification table 722. Therefore, the information processing system 1 can efficiently provide electronic data related to a commercial transaction in a store to a partner.

The above-described embodiments can be appropriately modified and implemented by changing a part of configurations or functions of the above-described device. Hereinafter, some modifications will be described as other embodiments. In the following, those aspects different from the already described embodiment(s) will be primarily described, and detailed description of points common to the already described embodiment(s) may be omitted. In addition, various modifications described below may be individually implemented or may be implemented in combination with each other as appropriate.

### Modification 1

In an embodiment, the store management device 20 acquires the sales file from the POS terminal 40 and transmits the acquired sales file to the store management server 70. However, the disclosure is not limited to this, and the sales file may be transmitted directly from the POS terminal 40 to the store management server 70 in other examples.

In such a case, the POS terminal 40 may incorporate functional units corresponding to the POS cooperation unit 2002 and the data providing unit 2003 included in the store management device 20 already described, and thus a modification can be implemented.

Accordingly, in this modification, it is possible to achieve substantially the same effects as those of the already described embodiment(s) without using a store management device 20.

### Modification 2

In an embodiment, the POS terminal 40 transmits the sales file to the store management device 20. However, the disclosure is not limited to this, and the POS terminal 40 may instead transmit an electronic journal file together with the sales file. In this context, the electronic journal file may include an electronic receipt indicating content of a transaction, an inspection (audit) of the POS terminal 40, a summary report file of settlement operations, an operation history of the POS terminal 40, an error report of the POS terminal 40, and/or the like.

In this case, when the store management device 20 receives the sales file and the electronic journal file from the POS terminal 40, the store management device 20 may combine the sales file and the electronic journal file, and otherwise treat the sales file and the electronic journal file as a sales file.

Accordingly, the store management server 70 can acquire and manage various types of other data stored in the POS terminal 40 together with the sales file.

### Modification 3

In an embodiment, the output control unit 7003 of the store management server 70 identifies the external server based on the output destination specification table 722 stored in the store management server 70, and outputs the sales file to the identified external server. However, the disclosure is not limited thereto, and the output control unit 7003 may instead transmit a notification indicating that there is a sales file to be acquired to the external server identified in the output destination specification table 722 instead of outputting the sales file or before outputting the sales file.

Accordingly, the external server can acquire (e.g., download) a sales file stored in the store management server 70 at a later timing appropriate for the external server.

### Modification 4

In an embodiment, the POS cooperation unit 2002 of the store management device 20 stores the sales file in the data management area 224 after the sales file is received from the POS terminal 40. However, since the data management area 224 of the store management device 20 may be limited, it may be preferable to prevent the data management area 224 from exceeding its capacity.

In this case, a holding upper limit number of the sales files may be stored in the setting information 221, and the control unit 200 of the store management device 20 may delete older sales file(s) once the holding upper limit number approaches or is reached.

Accordingly, it is possible to prevent a storage failure of newer (more recent) sales files due to limit on the capacity of the data management area 224.

Programs executed by an information processing device according to embodiments and modifications may be stored on a computer connected to a network such as the Internet and provided by being downloaded via the network. In addition, the programs executed by the information processing device according to the embodiments and the modifications may be accessed or distributed via a network such as the Internet.

The programs executed by the devices of the above-described embodiments can be provided by being incorporated in advance in a ROM, a storage unit, or the like. The programs executed by the devices in the above-described embodiments may be provided by being recorded in a non-transitory, computer-readable recording medium such as a CD-ROM, a flexible disk (FD), a CD-R, or a digital versatile disk (DVD) as a file in an installable or executable format.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A store data handling system, comprising:
a store management device configured to acquire electronic data related to merchandise sold by a store from a purchase handling device of the store; and
a server device including:
a storage unit storing an output destination specification table;
a communication interface connected to the store management device via a network to receive the electronic data from the store management device; and
a processor configured to:
store the electronic data received from the store management device in the storage unit,
compare the electronic data to output conditions in the output destination specification table to determine an output destination for the electronic data,
identify an output address of the determined output destination in the output destination specification table, the output address being an electronic address of an external server,
process the electronic data based on additional information in the output destination specification table associated with the output address, and
control the communication interface to transmit the processed electronic data to the output address.

2. The store data handling system according to claim 1, wherein the processing of the electronic data based on the additional information is a formatting of the electronic data for compatibility with the external server.

3. The store data handling system according to claim 1, wherein the processing of the electronic data based on the additional information is a masking of personal identifiable information in the electronic data.

4. The store data handling system according to claim 1, wherein the processing of the electronic data based on the additional information is a deletion or removal of personal identifiable information in the electronic data.

5. The store data handling system according to claim 1, wherein the processing of the electronic data based on the additional information is a removal of portions of information in the electronic data.

6. The store data handling system according to claim 1, wherein an output condition in the output destination specification table is a type of the purchase handling device from which the electronic data was acquired.

7. The store data handling system according to claim 1, wherein an output condition in the output destination specification table is a transaction type included in the electronic data.

8. The store data handling system according to claim 1, wherein the purchase handling device is one of a point-of-sale terminal, handheld store clerk terminal, or an external ordering terminal.

9. A restaurant data handling system, comprising:
a point-of-sale terminal;
a handheld store clerk terminal;
a kitchen slip printer;
a store management device configured to acquire electronic data related to merchandise sold by a store from the point-of-sale terminal, the handheld store clerk terminal, and an external ordering terminal and cause the kitchen slip printer to print order slips according to merchandise orders received by the point-of-sale terminal, the handheld store clerk terminal, and the external ordering terminal; and
a server device including:
a storage unit storing an output destination specification table;
a communication interface connected to the store management device via a network to receive the electronic data from the store management device; and
a processor configured to:
store the electronic data received from the store management device in the storage unit,
compare the electronic data to output conditions in the output destination specification table to determine an output destination for the electronic data,
identify an output address of the determined output destination in the output destination specification table, the output address being an electronic address of an external server,
process the electronic data based on additional information in the output destination specification table associated with the output address, and
control the communication interface to transmit the processed electronic data to the output address.

10. The restaurant data handling system according to claim 9, wherein the processing of the electronic data based on the additional information is a formatting of the electronic data for compatibility with the external server.

11. The restaurant data handling system according to claim 9, wherein the processing of the electronic data based on the additional information is a masking of personal identifiable information in the electronic data.

12. The restaurant data handling system according to claim 9, wherein the processing of the electronic data based on the additional information is a deletion or removal of personal identifiable information in the electronic data.

13. The restaurant data handling system according to claim 9, wherein the processing of the electronic data based on the additional information is a removal of portions of information in the electronic data.

14. The restaurant data handling system according to claim 9, wherein an output condition in the output destination specification table is a transaction type included in the electronic data.

15. A server device for a store data handling system, the server device comprising:
a storage unit for storing an output destination specification table for electronic data related to merchandise sold by a store form a purchase handling device of the store;
a communication interface connected to the store management device via a network to receive the electronic data from the store management device; and
a processor configured to:
store the electronic data received from the store management device in the storage unit,
compare the electronic data to output conditions in the output destination specification table to determine an output destination for the electronic data,
identify an output address of the determined output destination in the output destination specification table, the output address being an electronic address of an external server,
process the electronic data based on additional information in the output destination specification table associated with the output address, and
control the communication interface to transmit the processed electronic data to the output address.

16. The server device according to claim 15, wherein the processing of the electronic data based on the additional information is a formatting of the electronic data for compatibility with the external server.

17. The server device according to claim 15, wherein the processing of the electronic data based on the additional information is a masking of personal identifiable information in the electronic data.

18. The server device according to claim 15, wherein the processing of the electronic data based on the additional information is a deletion or removal of personal identifiable information in the electronic data.

19. The server device according to claim 15, wherein an output condition in the output destination specification table is a type of the purchase handling device from which the electronic data was acquired.

20. The server device according to claim 15, wherein an output condition in the output destination specification table is a transaction type included in the electronic data.
